(19) United States
(12) Patent Application Publication
(10) Pub. No.: US 2014/0036148 A1
(43) Pub. Date: Feb. 6, 2014

(54) APPARATUS AND METHOD FOR CONVERTING FRAME RATE OF VIDEO SIGNAL, AND VIDEO PROCESSING APPARATUS USING THE SAME

(71) Applicant: PANASONIC CORPORATION, Osaka (JP)

(72) Inventors: Satoru TANIGAWA, Hyogo (JP); Yuji SEKIGUCHI, Nara (JP)

(73) Assignee: PANASONIC CORPORATION, Osaka (JP)

(21) Appl. No.: 14/035,777

(22) Filed: Sep. 24, 2013

Related U.S. Application Data
(63) Continuation of application No. PCT/JP2011/006825, filed on Dec. 6, 2011.

(30) Foreign Application Priority Data
Apr. 1, 2011 (JP) 2011-081454

(51) Int. Cl. H04N 7/01

(52) U.S. Cl. CPC H04N 7/012
USPC 348/448

(57) ABSTRACT

In order to convert frame repetition information generated by pulldown processing for generating repeat frames from each frame of an input video signal generated at 24 fps into phase information for pulldown processing, and to perform frame rate conversion using the phase information, an apparatus for converting the frame rate of the video signal includes a repeat frame generation unit configured to generate, according to the predetermined number of repeat frames, a plurality of identical frames from each frame of the input video signal; and a frame rate conversion unit configured to perform frame rate conversion based on the frame phase information indicating the number of repeat frames generated by the repeat frame generation unit. Thus, even if a video picture generated at 24 fps is input, judder of a video picture displayed on a screen can be reduced upon frame rate conversion until pulldown processing is determined.

### CROSS-REFERENCE TO RELATED APPLICATIONS

This is a continuation of International Application No. PCT/JP2011/006825 filed on Dec. 6, 2011, which claims priority to Japanese Patent Application No. 2011-081454 filed on Apr. 1, 2011. The entire disclosures of these applications are incorporated by reference herein.

### BACKGROUND

The present disclosure relates to frame rate conversion apparatus and method for performing conversion of a frame rate to be used for, e.g., display apparatuses or video processing apparatuses and judder compensation for a pulldown signal.

With an increase in screen size and resolution, emphasis has been recently placed on display of a higher quality video picture on a television set using, e.g., a liquid crystal display device or a plasma display device. In order to smoothly display movement of an object(s) of a video picture on a screen, emphasis has been also placed on video processing for converting a frame rate. Increasing importance has been attached to the following frame rate conversion apparatus and method. A film footage or a video picture generated at 24 fps is converted into a film-originated signal by 2:3 pulldown, or an input video picture is converted into a video signal by 2:2 pulldown. Such an interlaced video signal converted by the foregoing pulldown is converted into a progressive signal to generate non-interlaced frames. As a result, movement of a video picture corresponding to the video signal converted by the foregoing pulldown can be smoothly displayed, and the frame rate of the video picture can be converted into the frame rate of a display apparatus.

In a conventional frame rate conversion apparatus, e.g., a signal converter determines whether or not an input signal is an interlaced signal or a non-interlaced signal. For the interlaced signal, a de-interlacing technique is used to convert the interlaced signal into a non-interlaced signal, and then the non-interlaced signal is input to a frame rate conversion circuit. On the other hand, the non-interlaced signal is input to the frame rate conversion circuit without conversion. A film-originated signal detector determines whether or not the input signal is a film-originated signal, and a film-originated flag is input to a de-interlacer and a frame rate converter (see, e.g., FIG. 1 of Japanese Patent Publication No. 2005-208613).

### SUMMARY

In the foregoing conventional frame rate conversion apparatus, a video signal into which a video signal generated at 24 fps is converted by pulldown processing in a video output apparatus is input. The film-originated signal detector requires at least the number of frames corresponding to one or more cycles of a repeat sequence until 3:2 pulldown or 2:2 pulldown is detected. Considering detection stability, additional cycles are further required, resulting in a longer pulldown detection time. Thus, it takes time until film footage processing begins. Until the processing is switched to film footage processing, movement of an object(s) contained in an output video picture changes every time a sequence of a plurality of identical frames (hereinafter referred to as “repeat frames”) is switched to a different sequence of repeat frames. This results in judder of the output video picture. In the case of a video picture having a small change between frames thereof, a difference in image between frames is small, and therefore it is difficult to detect 3:2 pulldown or 2:2 pulldown. As a result, it takes time to detect pulldown, and it is difficult to stably determine pulldown. In the case where image correction such as non-interlace conversion, tone correction, or contour correction is performed at an early stage of frame rate conversion, a corrected pulldown signal is input to the frame rate converter. Thus, there is a disadvantage that frames which should be determined as those containing the same image are susceptible to image correction and it is difficult to accurately detect 3:2 pulldown or 2:2 pulldown.

In view of the foregoing, the present disclosure is intended to provide a frame rate conversion apparatus which has an improved frame rate conversion performance in the case where a video signal generated at 24 fps is input and which is realized with less judder and with a short film footage detection time or stable pulldown determination upon frame rate conversion, and to improve an image quality of a display apparatus or a video processing apparatus by using the frame rate conversion apparatus.

According to the present disclosure, the following configuration is employed in order to solve the foregoing disadvantages. For example, a video signal generated at 24 fps is input. Frame repetition information generated by pulldown processing for generating repeat frames from each frame of the input video signal is converted into pulldown signal phase information, and then frame rate conversion is performed using the phase information.

Specifically, an apparatus for converting a frame rate of a video signal according to a first aspect of the invention includes a repeat frame generation unit configured to generate, according to the predetermined number of repeat frames, a plurality of identical frames from each frame of an input video signal; and a frame rate conversion unit configured to perform frame rate conversion based on frame phase information indicating the number of repeat frames generated by the repeat frame generation unit.

An apparatus for converting a frame rate of a video signal according to a third aspect of the invention includes a repeat frame generation unit configured to generate, according to the predetermined number of repeat frames, a plurality of identical frames from each frame of an input video signal; a switching unit configured to switch, according to a signal format, between a video signal output from the repeat frame generation unit and another input video signal; a film footage detector configured to detect film footage from a video signal output from the switching unit; and a frame conversion unit configured to perform frame rate conversion. If the video signal output from the repeat frame generation unit is selected, the frame rate conversion unit performs the frame rate conversion based on frame phase information indicating the number of repeat frames generated by the repeat frame generation unit. If the another input video signal is selected, the frame rate conversion unit performs the frame rate conversion based on phase information output from the film footage detector.

An apparatus for converting a frame rate of a video signal according to a fifth aspect of the invention includes a repeat frame generation unit configured to generate, according to the predetermined number of repeat frames, a plurality of identical frames from each frame of an input video signal; an interlace-to-progressive converter configured to convert an interlaced video signal into a progressive video signal; a selector configured to select, according to a signal format, one of the progressive video signal or other input video signals; a film footage detector configured to detect film footage from the input interlaced signal; a non-interlaced frame generation unit configured to switch, based on a detection result obtained by the film footage detector, interpolation in the interlace-to-progressive converter; and a frame rate conversion unit configured to perform frame rate conversion based on film phase information detected by the film footage detector or frame phase information indicating the number of repeat frames generated by the repeat frame generation unit.

An apparatus for converting a frame rate of a video signal according to a sixth aspect of the invention includes a repeat frame generation unit configured to generate, according to the predetermined number of repeat frames, a plurality of identical frames from each frame of an input video signal; an interlace-to-progressive converter configured to convert an interlaced video signal into a progressive video signal; a selector configured to select, if the input video signal is a progressive video signal, according to a signal format that the progressive video signal is output; a first film footage detector configured to detect film footage from the input video signal; a non-interlaced frame generation unit configured to switch, based on a detection result obtained by the first film footage detector, interpolation in the interlace-to-progressive converter; a second film footage detector configured to detect film footage from an output of the non-interlaced frame generation unit; and a frame rate conversion unit configured to perform frame rate conversion based on a detection result obtained by the second film footage detector, the second film footage detector switching a setting thereof for detection based on first film phase information detected by the first film footage detector or based on frame repetition information indicating the number of repeat frames of the input video signal.

According to the present disclosure, if, e.g., a video signal generated at 24 fps is input, at least the number of frames corresponding to one or more cycles of a repeat sequence is required until 3:2 pulldown or 2:2 pulldown is detected. However, since frame rate conversion is performed based on information on repeat frames for pulldown processing, a time required for pulldown detection can be shortened as much as possible. Moreover, until video processing is switched to film footage processing, movement of an object(s) contained in an output video picture can be prevented from changing every time a sequence of repeat frames is switched to a different sequence of repeat frames. As a result, judder of the output video picture can be reduced or prevented. In the case of a video picture having a small change between frames thereof, a difference in image between frames is small. However, since frame rate conversion is performed based on information on repeat frames for pulldown processing, the frame rate conversion can be performed regardless of the magnitude of difference between frames of an input video signal. Further, in the case where image correction such as tone correction or contour correction is performed at an early stage of frame rate conversion, a corrected pulldown signal is input for frame rate conversion. For such a reason, frames which should be determined as those containing the same image are susceptible to image correction and it is difficult to accurately detect 3:2 pulldown or 2:2 pulldown. However, in the present disclosure, there is little influence of image correction.

Since conversion to film phase information is performed based on a film footage detection result used for non-interlace conversion, the processing can be switched to frame rate conversion for film footage processing without detecting film footage during frame rate conversion. Frame rate conversion can be performed regardless of the magnitude of difference between frames of an input video signal, and frame rate conversion for film footage processing can be performed without an influence of interpolation upon non-interlace conversion or an influence of noise caused due to non-interlace conversion.

Based on information on repeat frames for pulldown processing or first film footage detection information obtained upon non-interlace conversion, the determination level of second film footage detection prepared for frame rate conversion is adjusted. Thus, a determination time required for the second film footage detection can be shortened, or a second film footage detection result can be compared with a first footage detection result. As a result, frame rate conversion can be performed using a more accurate film footage detection result.

### BRIEF DESCRIPTION OF THE DRAWINGS

FIG. 1 is a block diagram of a frame rate conversion apparatus of a first embodiment of the present disclosure.

FIG. 2 is a block diagram of a frame rate conversion apparatus of a second embodiment of the present disclosure.

FIG. 3 is a block diagram of a frame rate conversion apparatus of a third embodiment of the present disclosure.

FIG. 4 is a block diagram of a frame rate conversion apparatus of a fourth embodiment of the present disclosure.

FIG. 5 is a timing chart illustrating an operation of the first embodiment of the present disclosure.

FIG. 6 is a timing chart illustrating another operation of the first embodiment of the present disclosure.

FIG. 7 is a block diagram of a video processing apparatus using a frame rate conversion apparatus according to a fifth embodiment of the present disclosure.

### DETAILED DESCRIPTION

Embodiments of the present disclosure will be described below in detail with reference to drawings.

### First Embodiment

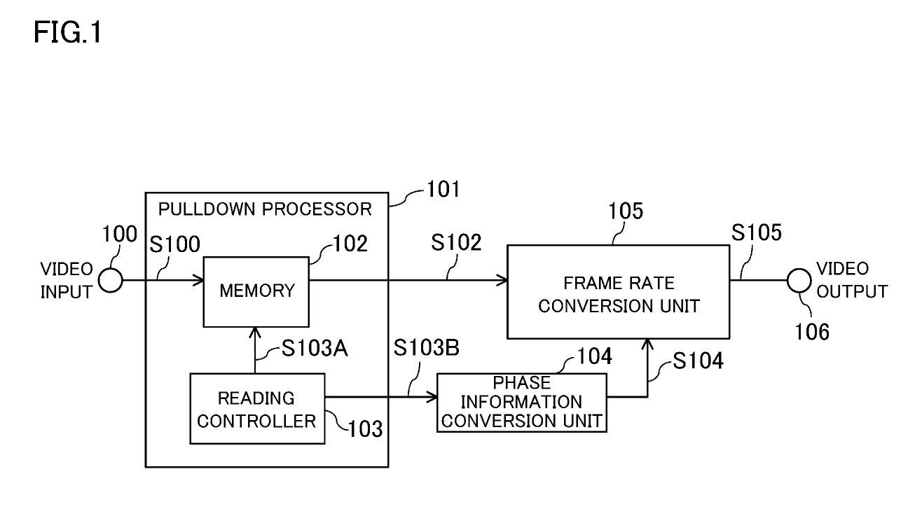

FIG. 1 is a block diagram illustrating an apparatus for converting the frame rate of a video signal according to a first embodiment of the present disclosure. Referring to FIG. 1, a film-originated signal S100 input from an input unit 100 is input to a pulldown processing unit 101, and then is written in a memory 102. A reading controller 103 reads a pulldown video signal S102 from the memory 102 based on a reading control signal S103A for repeatedly reading each of a plurality of frames, and then the pulldown video signal S102 is input to a frame rate conversion unit 105. Meanwhile, the reading controller 103 outputs frame repetition information S103B, and the frame repetition information S103B is input to a phase information conversion unit 104. The frame repetition information S103B is converted into frame phase information S104 in the phase information conversion unit 104. The frame rate conversion unit 105 performs frame rate conversion based on the frame phase information S104, and outputs a video signal S105 through an output unit 106.

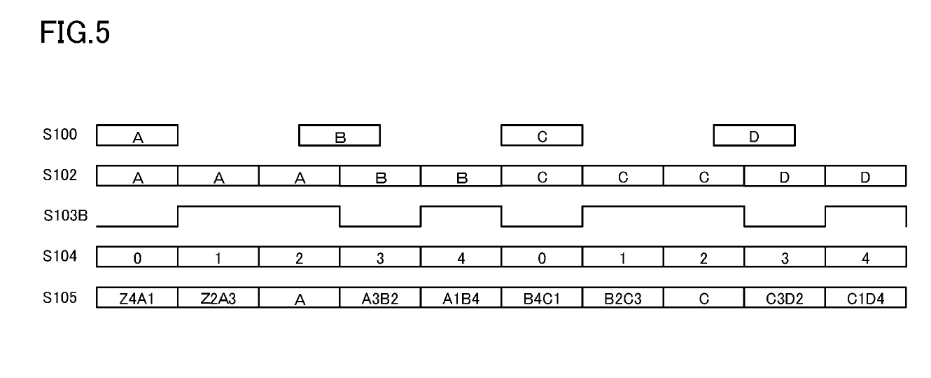

FIG. 5 is a timing chart for each signal of the frame rate conversion apparatus of the first embodiment, and an operation thereof will be described with reference to FIG. 5.

A film-originated signal S100 generated at 24 fps and containing frames A, B, C, D is input from the input unit 100, and then is input to the pulldown processing unit 101. The film-originated signal S100 is written at a vertical frequency of 24 Hz in the memory 102. Suppose that the input signal is read at a vertical frequency of 60 Hz. In the pulldown processing unit (repeat frame generation unit) 101, each frame generated in the reading controller 103 is converted into a plurality of frames. Thus, a pulldown video signal S102 which is, based on a reading control signal S103A for controlling addresses etc. of the memory 102, processed by such 3:2 pulldown that the frame A is converted into three frames A, the frame B is converted into two frames B, the frame C is converted into three frames C, and the frame D is converted into two frames D is output. Meanwhile, the reading controller 103 outputs frame repetition information S103B indicating sequences of repeat frames, and then is input to the phase information conversion unit 104. In the phase information conversion unit 104, frames corresponding to one cycle of repeat frames are, every 60 Hz, converted into frame phase information S104, and frame rate conversion is performed based on the frame phase information S104 in the frame rate conversion unit 105. FIG. 5 illustrates a video signal S105 output at a vertical frequency of 60 Hz, and a frame Z is a frame previous to the frame A. In the frame rate conversion unit 105, frame interpolation using motion compensation is performed. Based on frame phase information S104, frame interpolation using motion compensation is performed with the following weighting: frame Z:frame A=4:1; frame Z:frame A=2:3; frame A; frame A:frame B=3:2; and frame A:frame B=1:4. As a result, judder compensation for reducing or preventing judder caused in the case where a pulldown video signal S102 is output without conversion of repeat frames is performed. Thus, a video picture can be displayed with a smooth change in object movement in order of frames A, B, C, D.

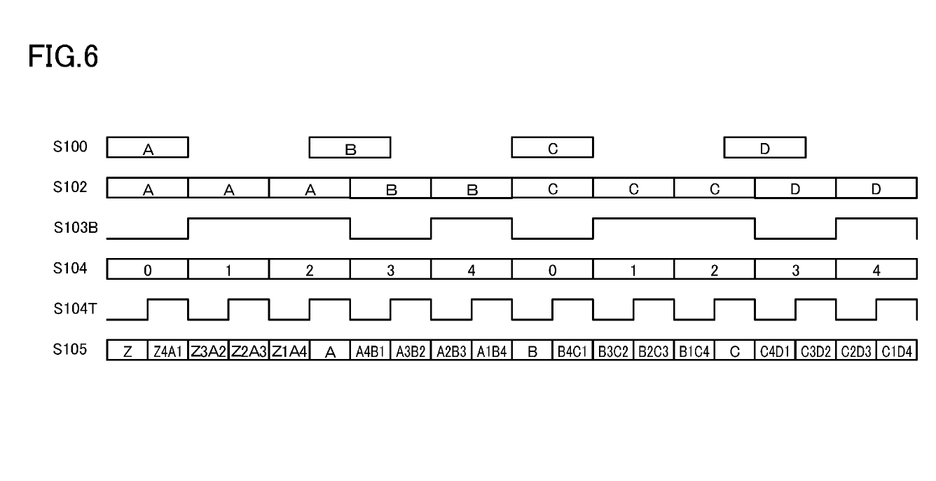

FIG. 6 is a timing chart for each signal of the frame rate conversion apparatus of the first embodiment, and illustrates the case where an output vertical frequency is doubled. Only differences of the case illustrated in FIG. 6 from the case illustrated in FIG. 5 will be described.

Suppose that the output frequency of the frame rate conversion unit 105 is 120 Hz. Since a frequency twice as high as that of frame phase information S104 is required, the frame phase information S104 is toggled at the output frequency to generate a signal S104T indicating a frame polarity. Then, based on the frame phase information S104 and the signal S104T, frame interpolation using motion compensation is performed at the double frequency. Frame interpolation using motion compensation is performed with the following weighting: frame Z; frame Z:frame A=4:1; frame Z:frame A=3:2; frame Z:frame A=2:3; frame Z:frame A=1:4; frame A; frame A:frame B=4:1; frame A:frame B=3:2; frame A:frame B=2:3; and frame A:frame B=1:4. As a result, judder compensation for reducing or preventing judder caused in the case where a pulldown video signal S102 is output without conversion of repeat frames is performed. Thus, while the frame rate of a video picture increases in order of frames A, B, C, D, the video picture can be displayed with a smooth change in object movement in order of frames A, B, C, D.

One example where a video signal generated at 24 fps is input as an input signal and 3:2 pulldown is performed has been described. Such an example does not limit the input signal to a signal generated at 24 fps. Any video signals generated at 25 fps, 30 fps, or more may be input. Moreover, pulldown processing is not limited to 3:2 pulldown, and 2:2 pulldown or other m:n pulldown (“m” and “n” are integers) may be employed. Further, for the output vertical frequency of the frame rate conversion unit 105, various types of frame rate conversion are available by changing phase information and weighting. Part of video processing may be implemented by software. Note that the pulldown processing unit 101, the frame rate conversion unit 105, the memory 102, etc. may be made of the same semiconductor, or may be a display apparatus or a video processing apparatus formed by combining separate semiconductors.

### Second Embodiment

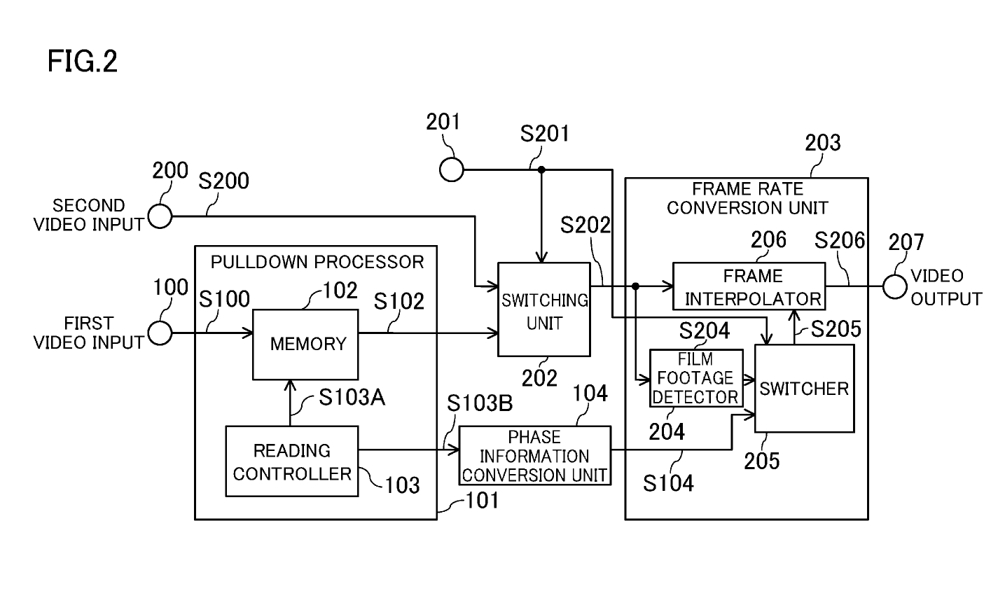

FIG. 2 is a block diagram illustrating an apparatus for converting the frame rate of a video signal according to a second embodiment of the present disclosure. The same reference numerals as those shown in FIG. 1 will be used to represent equivalent elements in FIG. 2, and the description thereof will not be repeated. Referring to FIG. 2, a non-interlaced video signal S200 input from an input unit 200 is input to a switching unit 202. The switching unit 202 selects one of the non-interlaced video signal S200 or a pulldown video signal S102 based on a selection signal S201 input from an input unit 201, thereby outputting the selected one to a frame rate conversion unit 203 as a video signal S202. The selection signal S201 is controlled by, e.g., a microcomputer when an input signal is switched by, e.g., a remote controller or is automatically detected. The video signal S202 is input to a film footage detector 204 and a frame interpolator 206 using motion compensation. One of first phase information S104 or second phase information S204 detected in the film footage detector 204 is selected by a switcher 205, and then the selected one is output as phase information S205. Based on the phase information S205, frame rate conversion is performed in the frame interpolator 206 using motion compensation, and then a video signal S206 is output through an output unit 207.

If the non-interlaced video signal 5200 is selected based on the selection signal S201, a detection result of the film footage detector 204 is selected as the phase information S205, thereby determining whether the non-interlaced video signal is a pulldown signal or a non-pulldown signal. If the non-interlaced video signal is the pulldown signal, judder compensation is, based on the detected phase information, performed for the pulldown signal by frame interpolation using motion compensation. If a video signal is input to the video processing apparatus in advance and a pulldown pattern is already set in the video processing apparatus, frame repetition information can be used to generate phase information, thereby shortening a pulldown detection time and obtaining a stable pulldown determination result. Thus, occurrence of judder can be reduced.

### Third Embodiment

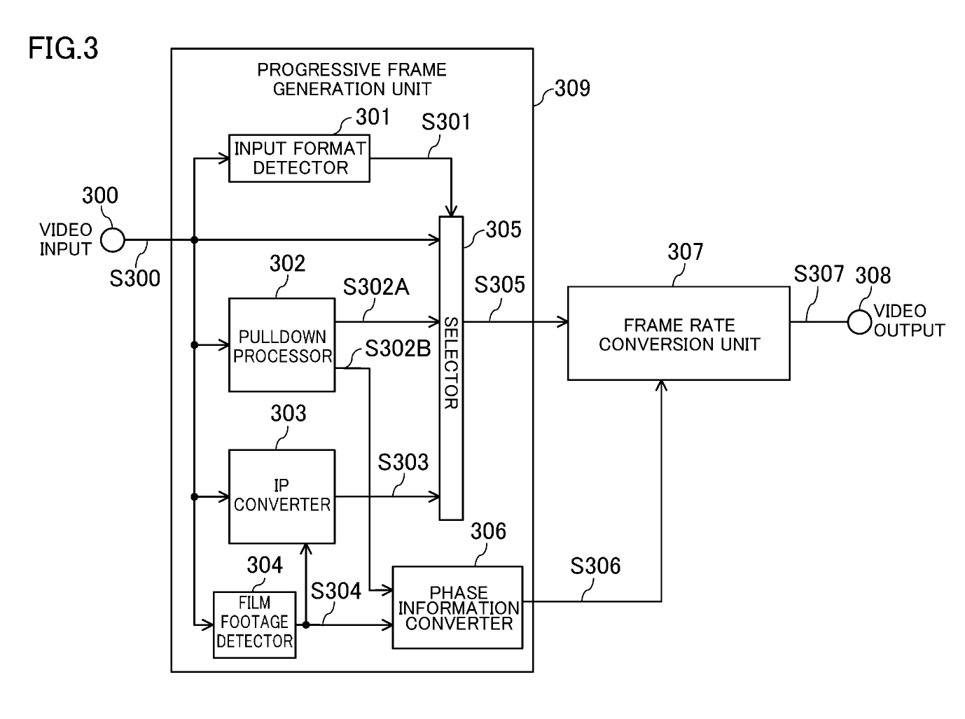

FIG. 3 is a block diagram illustrating an apparatus for converting the frame rate of a video signal according to a third embodiment of the present disclosure. Referring to FIG. 3, a video signal S300 input from an input unit 300 is input to an input format detector 301, a pulldown processor 302, an interlace-to-progressive (IP) converter 303, and a film footage detector 304. The input format detector 301 detects the format of the video signal S300, i.e., detects whether the video signal S300 is a non-interlaced signal, a film-originated signal generated at, e.g., 24 fps, or an interlaced signal, and then outputs a selection signal S301. If the video signal S300 is the film-originated signal generated at, e.g., 24 fps, pulldown processing is performed as in the first embodiment. Then, a pulldown video signal S302A is selected by a selector 305, and the selector 305 outputs a selected video signal S305. Meanwhile, the pulldown processor 302 outputs frame repetition information S302B to a phase information converter 306. If the video signal S300 is the interlaced signal, the video signal S300 is converted into a non-interlaced signal in the IP converter 303. The film footage detector 304 determines whether or not the video signal S300 is a pulldown signal. If the video signal S300 is an interlaced pulldown signal, a non-interlaced video signal S303 is, based on a detection result S304, generated by IP conversion of odd fields and even fields forming a signal frame in the IP converter 303. In the selector 305, the non-interlaced video signal S303 is selected, and then a selected video signal S305 is output. Meanwhile, the detection result S304 is input to the phase information converter 306. If the video signal S300 is a non-interlaced pulldown signal, the video signal S300 is selected by the selector 305, and then a selected video signal S305 is output. Meanwhile, the detection result S304 is input to the phase information converter 306. In the phase information converter 306, the frame repetition information S302B or the detection result S304 is converted into frame phase information S306. Based on the selected video signal S305 and the frame phase information S306 corresponding thereto, frame rate conversion using motion compensation is performed in a frame rate conversion unit 307. Then, a video signal S307 having the converted frame rate is output through an output unit 308.

It has been described that, if the video signal S300 is a non-interlaced signal, the video signal S300 is selected by the selector 305. However, progressive processing may be performed as necessary by, e.g., changing the format of the input progressive video signal.

### Fourth Embodiment

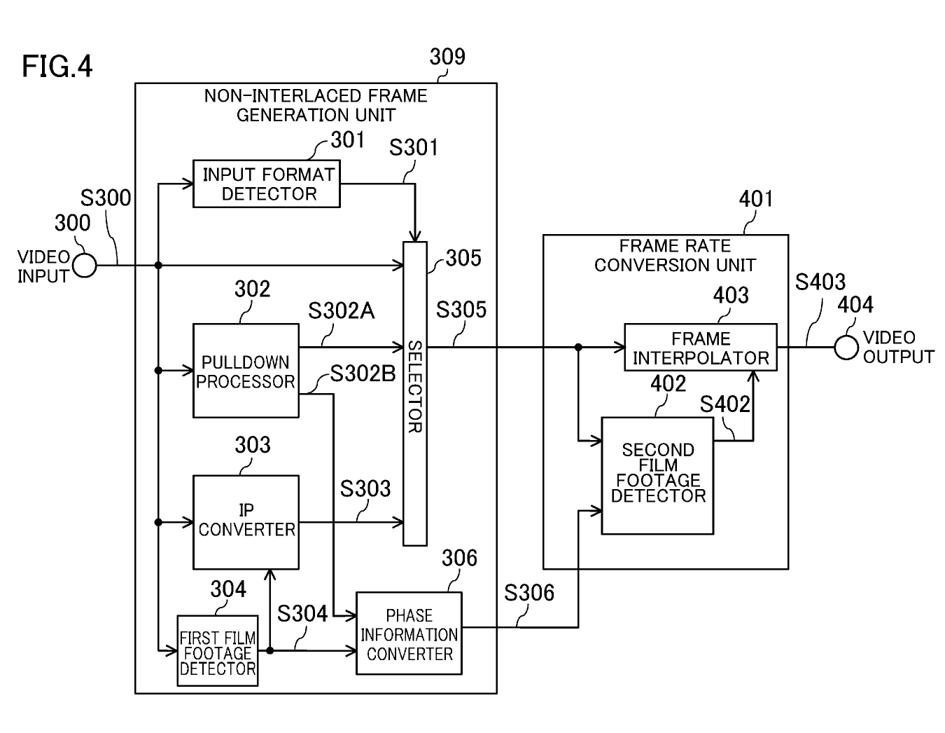

FIG. 4 is a block diagram illustrating an apparatus for converting the frame rate of a video signal according to a fourth embodiment of the present disclosure. The same reference numerals as those shown in the third embodiment will be used to represent equivalent elements in the present embodiment, and the description thereof will not be repeated. Referring to FIG. 4, the film footage detector 304 illustrated in FIG. 3 is provided as a first film footage detector 304, and a second film footage detector 402 is further provided.

In the present embodiment, a selected video signal S305 and frame phase information S306 corresponding thereto are input to a frame rate conversion unit 401. The selected video signal S305 is input to the second film footage detector 402 and a frame interpolator 403 using motion compensation. The second film footage detector 402 determines whether or not the selected video signal S305 is a pulldown video signal. If the pulldown video signal is detected, frame phase information S402 is input to the frame interpolator 403 using motion compensation, and then frame rate conversion using motion compensation is performed. Then, a video signal S403 having the converted frame rate is output through an output unit 404. In the second film footage detector 402, the determination level of film footage detection performed by the second film footage detector 402 is adjusted with reference to the frame phase information S306 output from the phase information converter 306, and therefore the speed and reliability of film footage detection performed by the second film footage detector 402 can be increased. As one example of adjustment of the determination level, a time required for determination can be shortened by decreasing a threshold value for the number of detections of the same pulldown pattern as that detected by a non-interlaced frame generation unit 309. If the second film footage detector 402 detects a pulldown pattern different from that detected by the non-interlaced frame generation unit 309, a detection result of the second film footage detector 402 is not validated. If the same pulldown pattern as that detected by the non-interlaced frame generation unit 309 is stably detected, or the detection result of the second film footage detector 402 varies between the same detection result as that of the non-interlaced frame generation unit 309 and the detection result different from that of the non-interlaced frame generation unit 309, the detection result of the non-interlaced frame generation unit 309 is held without considering the detection result of the second film footage detector 402, and therefore switching of the detection result can be reduced. Thus, as compared to the case where only the second film footage detector 402 is provided, a detection time can be shortened by using information detected by the non-interlaced frame generation unit 309, and therefore detection stability can be further realized.

### Fifth Embodiment

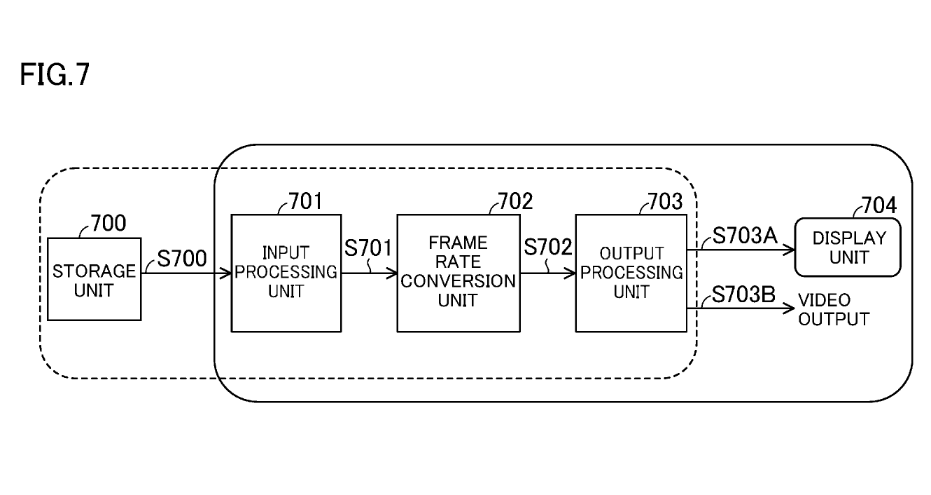

FIG. 7 is a block diagram illustrating a video processing apparatus using a frame rate conversion apparatus according to a fifth embodiment of the present disclosure. Referring to FIG. 7, a reference numeral “700” represents a storage unit such as DVD discs, Blu-ray discs, or hard discs, a reference numeral “701” represents an input processing unit configured to reproduce video signals recorded from broadcasting or video signals from recording media, a reference numeral “702” represents the frame rate conversion apparatus of any one of the first to fourth embodiments, a reference numeral “703” represents an output processing unit configured to output a video signal to an external unit or a display unit, and a reference numeral “704” represents a display unit such as liquid crystal displays or plasma displays.

In the input processing unit 701 configured to process video data generated or recorded in the storage unit 700, film footage is generated at 24 Hz. For example, the 24 Hz film footage is converted into a 60 Hz 2:3 pulldown signal by using the frame rate conversion apparatus as described in the first embodiment, and frame rate conversion is performed based on frame phase information per pulldown signal cycle. Since the video signal having the converted frame rate is output from the output processing unit 703 to the external unit, such a video signal is processed into such a signal format that the video signal can be output via connection through a cable or via wireless connection. For display of a video picture on the display unit 704, a synchronization signal to be reference for display and a timing signal for controlling a display apparatus are, in addition to a video signal, generated and processed to display the video picture on a screen of the display apparatus.

The display unit 704 is required for video processing apparatuses configured to display a video picture on a screen, such as television sets or displays. However, video processing apparatuses, such as DVDs, Blu-ray discs, or hard discs, configured to record and/or reproduction a video picture can be realized with a configuration which does not include the display unit 704, and a video signal having a converted frame rate is output via an output terminal connected to the external unit.

As described above, the frame rate conversion apparatus and method of the present disclosure is useful as apparatus and method for performing conversion of a frame rate to be used for, e.g., display apparatuses, video processing apparatuses, or television sets and judder compensation for a pulldown video signal.

What is claimed is:

1. An apparatus for converting a frame rate of a video signal, comprising:
a repeat frame generation unit configured to generate, according to the predetermined number of repeat frames, a plurality of identical frames from each frame of an input video signal; and
a frame rate conversion unit configured to perform frame rate conversion based on frame phase information indicating the number of repeat frames generated by the repeat frame generation unit.

2. The apparatus of claim 1, wherein
the repeat frame generation unit is configured to generate, according to the number of repeat frames for m:n pulldown where m and n are integers, a plurality of identical frames from each frame of the input video signal.

3. An apparatus for converting a frame rate of a video signal, comprising:
a repeat frame generation unit configured to generate, according to the predetermined number of repeat frames, a plurality of identical frames from each frame of an input video signal;
a switching unit configured to switch, according to a signal format, between a video signal output from the repeat frame generation unit and another input video signal;
a film footage detector configured to detect film footage from a video signal output from the switching unit; and
a frame conversion unit configured to perform frame rate conversion,
wherein, if the video signal output from the repeat frame generation unit is selected, the frame rate conversion unit performs the frame rate conversion based on frame phase information indicating the number of repeat frames generated by the repeat frame generation unit, and
if the another input video signal is selected, the frame rate conversion unit performs the frame rate conversion based on phase information output from the film footage detector.

4. The apparatus of claim 3, wherein
the repeat frame generation unit is configured to generate, according to the number of repeat frames for m:n pulldown where m and n are integers, a plurality of identical frames from each frame of the input video signal.

5. An apparatus for converting a frame rate of a video signal, comprising:
a repeat frame generation unit configured to generate, according to the predetermined number of repeat frames, a plurality of identical frames from each frame of an input video signal;
an interlace-to-progressive converter configured to convert an interlaced video signal into a progressive video signal;
a selector configured to select, according to a signal format, one of the progressive video signal or other input video signals;
a film footage detector configured to detect film footage from the input interlaced signal;
a non-interlaced frame generation unit configured to switch, based on a detection result obtained by the film footage detector, interpolation in the interlace-to-progressive converter; and
a frame rate conversion unit configured to perform frame rate conversion based on film phase information detected by the film footage detector or frame phase information indicating the number of repeat frames generated by the repeat frame generation unit.

6. An apparatus for converting a frame rate of a video signal, comprising:
a repeat frame generation unit configured to generate, according to the predetermined number of repeat frames, a plurality of identical frames from each frame of an input video signal;
an interlace-to-progressive converter configured to convert an interlaced video signal into a progressive video signal;
a selector configured to select, if the input video signal is a progressive video signal, according to a signal format that the progressive video signal is output;
a first film footage detector configured to detect film footage from the input video signal;
a non-interlaced frame generation unit configured to switch, based on a detection result obtained by the first film footage detector, interpolation in the interlace-to-progressive converter;
a second film footage detector configured to detect film footage from an output of the non-interlaced frame generation unit; and
a frame rate conversion unit configured to perform frame rate conversion based on a detection result obtained by the second film footage detector, the second film footage detector switching a setting thereof for detection based on first film phase information detected by the first film footage detector or based on frame repetition information indicating the number of repeat frames of the input video signal.

7. The apparatus of claim 6, wherein
the setting of the second film footage detector is a threshold value for the number of frames upon the detection, and
the threshold value for the number of frames required for pulldown detection performed by the first film footage detector is set less than the threshold value for the number of frames required for another pulldown detection performed by the first film footage detector.

8. The apparatus of claim 6, wherein
the setting of the second film footage detector is comparison in pulldown patterns, and
if a pulldown pattern detected by the first film footage detector is different from that detected by the second film footage detector, a detection result obtained by the second film footage detector is invalidated, and the frame rate conversion based on the detection result of the second film footage detector is not performed.

9. The apparatus of claim 6, wherein
the setting of the second film footage detector is comparison in pulldown patterns, and
when a pulldown pattern detection result obtained by the second film footage detector varies, if a pulldown pattern detected by the first film footage detector is fixed and is identical to that detected by the second film footage detector, the detection result obtained by the second film footage detector is held, and the frame rate conversion is performed based on the held detection result obtained by the second film footage detector.

10. An apparatus for converting a frame rate of a video signal, comprising:
a repeat frame generation unit configured to generate, according to the predetermined number of repeat frames, a plurality of identical frames from each frame of an input video signal;
an interlace-to-progressive converter configured to convert an interlaced video signal into a progressive video signal;
a selector to which at least one of an output of the repeat frame generation unit, an output of the interlace-to-progressive converter, or the input video signal is input and which is configured to select any one of the at least one of the outputs according to a signal format;
a first film footage detector configured to detect film footage from the input video signal;
a non-interlaced frame generation unit configured to switch, based on a detection result obtained by the first film footage detector, interpolation in the interlace-to-progressive converter;
a second film footage detector configured to detect film footage from an output of the non-interlaced frame generation unit; and
a frame rate conversion unit configured to perform frame rate conversion based on a detection result obtained by the second film footage detector, the second film footage detector switching a setting thereof for detection based on first film phase information detected by the first film footage detector or based on frame repetition information indicating the number of repeat frames of the input video signal.

11. The apparatus of claim 10, wherein
the setting of the second film footage detector is a threshold value for the number of frames upon the detection, and
the threshold value for the number of frames required for pulldown detection performed by the first film footage detector is set less than the threshold value for the number of frames required for another pulldown detection performed by the first film footage detector.

12. The apparatus of claim 10, wherein
the setting of the second film footage detector is comparison in pulldown patterns, and
if a pulldown pattern detected by the first film footage detector is different from that detected by the second film footage detector, a detection result obtained by the second film footage detector is invalidated, and the frame rate conversion based on the detection result of the second film footage detector is not performed.

13. The apparatus of claim 10, wherein
the setting of the second film footage detector is comparison in pulldown patterns, and
when a pulldown pattern detection result obtained by the second film footage detector varies, if a pulldown pattern detected by the first film footage detector is fixed and is identical to that detected by the second film footage detector, the detection result obtained by the second film footage detector is held, and the frame rate conversion is performed based on the held detection result obtained by the second film footage detector.

14. A method for converting a frame rate of a video signal, comprising:
a repeat frame generation step of generating, according to the predetermined number of repeat frames, a plurality of identical frames from each frame of an input video signal; and
a frame rate conversion step of performing frame rate conversion based on frame phase information indicating the number of repeat frames generated at the repeat frame generation step.

15. A method for converting a frame rate of a video signal, comprising:
a repeat frame generation step of generating, according to the predetermined number of repeat frames, a plurality of identical frames from each frame of an input video signal;
a switching step of switching, according to a signal format, between a video signal output from a repeat frame generation unit and another input video signal;
a film footage detection step of detecting film footage from a video signal output from a switching unit; and
a frame conversion step of performing frame rate conversion,
wherein, if the video signal output from the repeat frame generation unit is selected, the frame rate conversion is performed based on frame repetition information indicating frame repetition of the input video signal, and
if the another input video signal is selected, the frame rate conversion is performed based on information obtained at the film footage detection step.

16. A video processing apparatus comprising:
an input processing unit configured to process a signal input from broadcasting or video equipment;
the apparatus of any one of claims 3, 6, 10, and 15 configured to convert a frame rate of a video signal output from the input processing unit; and
an output conversion unit configured to display the video signal having the converted frame rate on a display unit.

17. A video processing apparatus comprising:
an input processing unit configured to process a signal decoded from a broadcasting signal or a signal reproduced from a storage unit;
the apparatus of any one of claims 3, 6, 10, and 15 configured to convert a frame rate of a video signal output from the input processing unit; and
an output processing unit configured to output the video signal having the converted frame rate to an external unit.
